(19) United States
(12) Patent Application Publication
(10) Pub. No.: US 2015/0185013 A1
(43) Pub. Date: Jul. 2, 2015

(54) ESTIMATION APPARATUS FOR ESTIMATING STATE OF ONE OBJECT COMING INTO CONTACT WITH THE OTHER OBJECT

(71) Applicant: CASIO COMPUTER CO., LTD., Tokyo (JP)

(72) Inventor: Kazuaki ABE, Iruma-shi (JP)

(73) Assignee: CASIO COMPUTER CO., LTD., Shibuya-ku (JP)

(21) Appl. No.: 14/582,152

(22) Filed: Dec. 23, 2014

(30) Foreign Application Priority Data
Dec. 27, 2013 (JP) 2013-273315

(51) Int. Cl. G01C 19/5776

(52) U.S. Cl. CPC G01C 19/5776

(57) ABSTRACT

A state estimation apparatus has a three-axis angular velocity sensor and a state estimation unit. The three-axis angular velocity sensor obtains a value of an angular velocity around a predetermined axis in a tennis racket when a tennis ball and the tennis racket come into contact. The state estimation unit estimates a contact position of the tennis ball on the tennis racket based on the obtained value of the angular velocity.

### BACKGROUND

1. Technical Field

The present invention relates to an estimation apparatus for estimating a state of one object coming into contact with the other object, an estimation method, and a recording medium.

2. Related Art

Conventionally, there have been known techniques for estimating a hitting position of a ball on a face of a golf club based on a hitting sound of the face of the golf club and the ball as disclosed in WO 2006/090638 A1.

### SUMMARY

An estimation apparatus includes: a first obtaining unit configured to obtain a value of an angular velocity around a predetermined rotation axis of a first object, the value of the angular velocity acquired in time when the first object and a second object come into contact with each other; and an estimation unit configured to estimate a contact position of the second object on the first object based on the value of the angular velocity obtained by the first obtaining unit.

An estimation method using an estimation apparatus includes: obtaining a value of an angular velocity around a predetermined rotation axis of a first object, the value of the angular velocity acquired in time when the first object and a second object come into contact with each other; and estimating a contact position of the second object on the first object based on the obtained value of the angular velocity.

A non-volatile computer-readable recording medium stores a program for causing a computer to execute functions as: obtaining unit configured to obtain a value of an angular velocity around a predetermined rotation axis of a first object, the value of the angular velocity acquired in time when the first object and a second object come into contact with each other; and estimating unit configured to estimate a contact position of the second object on the first object based on the value of the angular velocity obtained by the obtaining unit.

### BRIEF DESCRIPTION OF THE DRAWINGS

FIG. 1 is a block diagram illustrating a configuration of a hardware configuration of a state estimation apparatus according to one embodiment of the present invention;

FIGS. 2A and 2B are schematic diagrams illustrating a configuration of a sensor unit mounted to a tennis racket;

FIG. 3 is a functional block diagram illustrating a functional configuration for executing a state estimation process of a functional configuration of the state estimation apparatus;

FIGS. 4A and 4B are schematic diagrams illustrating a direction of a face deflection at a shot;

FIGS. 5A and 5B are diagrams illustrating a relationship between a face deflection state at the shot and detected values of a three-axis angular velocity sensor, FIG. 5A illustrates a state where a tennis ball hits at the upper side of a sweet spot, and FIG. 5B illustrates a state where the tennis ball hits at the lower side of the sweet spot;

FIG. 6 is a schematic diagram illustrating magnitude of a deflection of a ball hitting position from a grip axis;

FIG. 7 is a schematic diagram illustrating detected results of the ball hitting positions in forehand strokes;

FIG. 8 is a schematic diagram illustrating detected results of the ball hitting positions in backhand strokes;

FIG. 9 is a schematic diagram illustrating detected results of the ball hitting positions in aces;

FIG. 10 is a diagram illustrating an example of a display form in which estimation results of the state of swings are indicated by a histogram;

FIG. 11 is a flowchart illustrating an example of a flow of a state estimation process executed by the state estimation apparatus of FIG. 1 having the functional configuration of FIG. 3; and

FIG. 12 is a flowchart illustrating an example of a flow of a state estimation process executed by a state estimation apparatus according to a second embodiment.

### DETAILED DESCRIPTION

Embodiments of the present invention will be described below by using the drawings.

### First Embodiment

### Entire Hardware Configuration

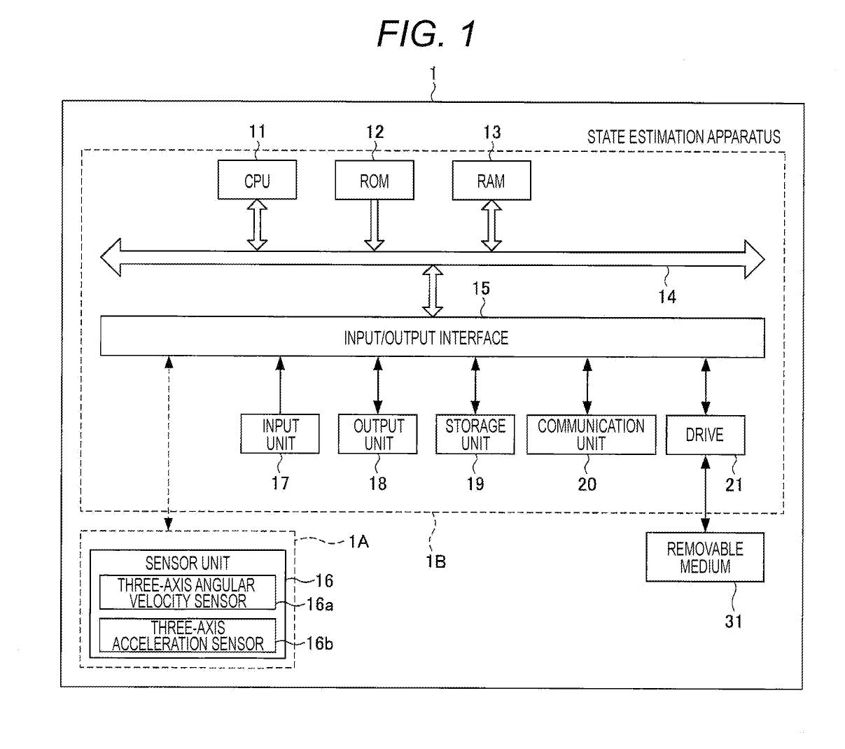

FIG. 1 is a block diagram illustrating a configuration of a hardware configuration of a state estimation apparatus 1 according to one embodiment of the present invention.

A state estimation apparatus 1 includes a sensor unit 1A having a three-axis angular velocity sensor and a three-axis acceleration sensor, and a processing unit 1B adapted to execute a state estimation process (described later) based on the value of the angular velocity and the value of the acceleration obtained by the sensor unit 1A.

The state estimation apparatus 1 has a CPU (Central Processing Unit) 11, ROM (Read Only Memory) 12, RAM (Random Access Memory) 13, a bus 14, an input/output interface 15, a sensor unit 16, an input unit 17, an output unit 18, a storage unit 19, a communication unit 20, and a drive 21. Among these elements, the CPU 11, the ROM 12, the RAM 13, the bus 14, and input/output interface 15, the input unit 17, the output unit 18, the storage unit 19, the communication unit 20, and the drive 21 are provided to the processing unit 1B configured by a PC (Personal Computer) and the like, while the sensor unit 16 is provided to the sensor unit 1A. The sensor unit 1A and the processing unit 1B are configured to be able to communicate through a communication interface (not shown) by wired or radio communications.

The CPU 11 executes various processes according to a program stored in the ROM 12 or a program loaded to the RAM 13 from the storage unit 19.

In the RAM 13, the data and the like that are necessary when the CPU 11 executes the various processes is also stored as required.

The CPU 11, the ROM 12, and the RAM 13 are connected to each other via the bus 14. The input/output interface 15 is also connected to the bus 14. The input unit 17, the output unit 18, the storage unit 19, the communication unit 20, and the drive 21 are connected to the input/output interface 15. It is noted that a three-axis angular velocity sensor 16a and a three-axis acceleration sensor 16b of the sensor unit 1A are also connected to the input/output interface 15 via a not-shown communication interface.

The sensor unit 16 includes the three-axis angular velocity sensor 16a and the three-axis acceleration sensor 16b. The sensor unit 16 is provided to the sensor unit 1A side and mounted to a tennis racket 2.

The three-axis angular velocity sensor 16a obtains values of respective angular velocity in X, Y, and Z axis directions in a swing of the tennis racket 2. The three-axis angular velocity sensor 16a then outputs, to the processing unit 1B, a signal indicating the obtained values of the angular velocity.

The three-axis acceleration sensor 16b obtains values of respective acceleration in X, Y, and Z axis directions in the swing of the tennis racket 2. The three-axis acceleration sensor 16b then outputs, to the processing unit 1B, a signal indicating the obtained values of the acceleration.

The input unit 17 is configured by various buttons and inputs various information according to the user instruction operation.

The output unit 18 is configured by a display, a speaker, and/or the like and outputs an image and/or a sound.

The storage unit 19 is configured by a hard disk, DRAM (Dynamic Random Access Memory), or the like and stores various data such as the data concerning the state estimation process and the like.

The communication unit 20 controls communications with other devices (not shown) via a network including the Internet.

A removable medium 31, which is a magnetic disk, an optical disk, a magneto-optical disk, a semiconductor memory, or the like, is inserted to the drive 21 as required. The program read out from the removable medium 31 by the drive 21 is installed to the storage unit 19 if necessary. Further, similarly to the storage unit 19, the removable medium 31 is able to store various data stored in the storage unit 19 as well.

### [Configuration of the Sensor Unit]

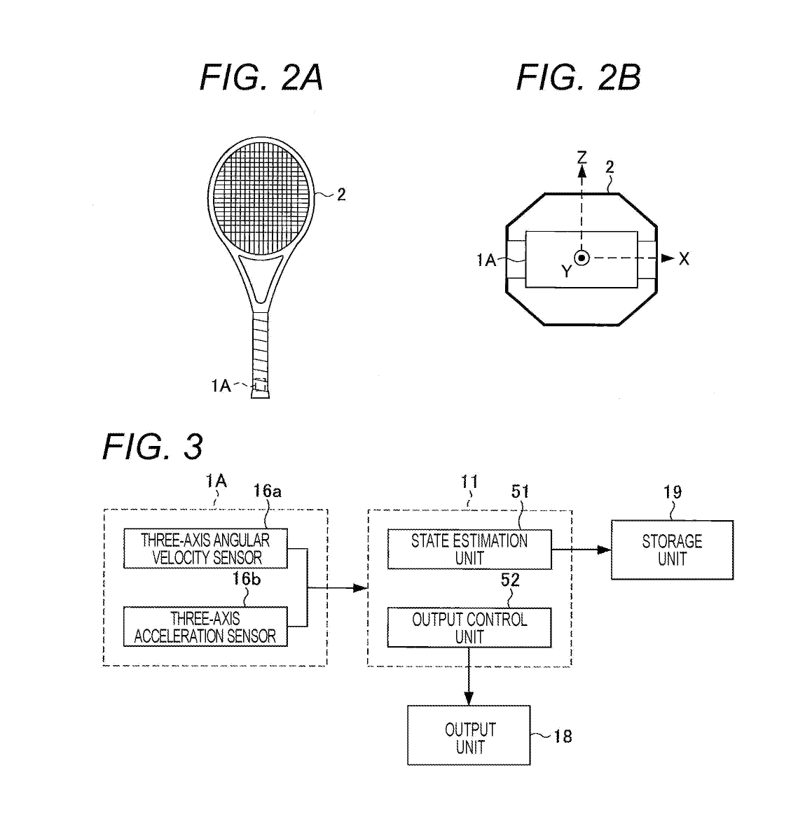

FIGS. 2A and 2B are schematic diagrams illustrating a configuration of the sensor unit 1A mounted to the tennis racket 2. In FIGS. 2A and 2B, FIG. 2A is an entire view of the tennis racket 2 to which the sensor unit 1A is mounted and FIG. 2B is an enlarged view of the sensor unit 1A mounted to the tennis racket 2. It is noted that FIG. 2B illustrates a state where the tennis racket 2 is viewed from the front of the grip end, together with the X, Y, and Z axes that are set in the sensor unit 1A.

As illustrated in FIGS. 2A and 2B, the sensor unit 1A is mounted inside the grip of the tennis racket 2 (in more detail, in a space inside the hollow grip). By the sensor unit 1A being mounted inside the grip, it can be suppressed that the swing of the tennis racket 2 by the player (the user) is obstructed. It is noted that, as long as the sensor unit 1A is located at the position that does not obstruct the swing made by the player, it may be set to the grip end or mounted inside the throat (the forked part of the shaft) of the tennis racket 2.

The sensor unit 1A mounted as described above obtains the values of the angular velocity and the values of the acceleration in the width direction of the face (the X axis direction), in the direction from the grip end to the racket head (the Y axis direction), and in the direction orthogonal to the face (the Z axis direction) by the three-axis angular velocity sensor 16a and the three-axis acceleration sensor 16b, respectively, when the tennis racket 2 is swung.

For example, in response that the right-handed player makes a forehand swing while keeping the face of the tennis racket 2 orthogonal to the ground, the angular velocity (−Gx) component around the X axis becomes the primary component of the obtained result by the three-axis angular velocity sensor 16a.

The sensor unit 1A then transmits a signal indicating the obtained values of the angular velocity and values of the acceleration to the processing unit 1B of the state estimation apparatus 1. In the processing unit 1B, various parameters on the swing of the player are calculated and the state of the swing is estimated. In the present embodiment, the state estimation apparatus 1 estimates, as the state of the swing, a deflection at the ball hitting position on the face with respect to the grip axis.

### [Functional Configuration]

FIG. 3 is a functional block diagram illustrating a functional configuration for executing the state estimation process of the functional configuration of the state estimation apparatus 1 as described above.

The state estimation process refers to a series of the processes of calculating the various parameters on the swing of the player and estimating the state of the swing made by the player based on the value of the angular velocity and the value of the acceleration in the swing of the tennis racket 2.

When the state estimation process is executed, a state estimation unit 51 and an output control unit 52 function in the CPU 11.

It is noted that at least a part of the function of the state estimation unit 51 may be transferred to the sensor unit 1A side.

The state estimation unit 51 obtains the values of the angular velocity in the X, Y, and Z axis directions of the tennis racket 2 obtained by the three-axis angular velocity sensor 16a. Further, the state estimation unit 51 obtains the values of the acceleration in the X, Y, and Z axis directions of the tennis racket 2 obtained by the three-axis acceleration sensor 16b. The state estimation unit 51 then estimates the state of the swing of the tennis racket 2 by the player based on the obtained values of the angular velocity and values of the acceleration.

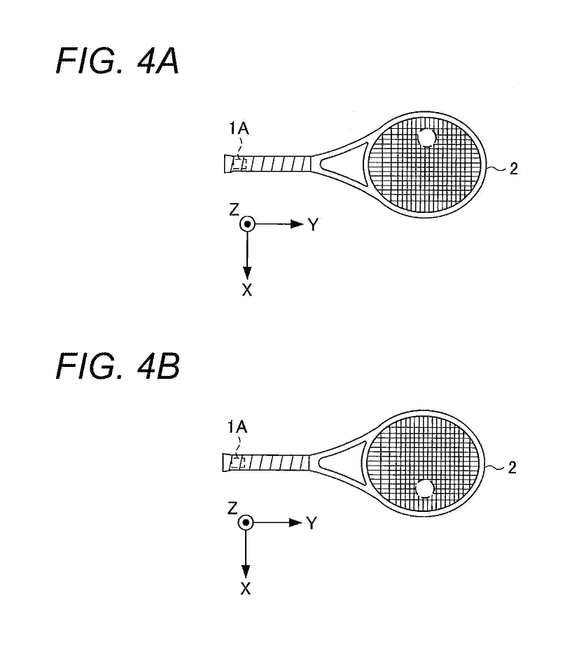

FIGS. 4A and 4B are schematic diagrams illustrating the direction of the face deflection (the rotation around the Y axis) at a shot. It is noted that FIGS. 4A and 4B illustrate a state viewed from the backside of the shot direction when the right handed player makes a forehand stroke.

As illustrated in FIGS. 4A and 4B, when the right handed player makes a forehand stroke and when the tennis ball hits at the upper side of a sweet spot (the center of the face) (see FIG. 4A), the value of the angular velocity Gy immediately after the impact is a value of a right rotation (a positive value) due to the impact of the shot. In contrast, when the tennis ball hits at the lower side of the sweet spot (see FIG. 4B), the value of the angular velocity Gy immediately after the impact is a value of a left rotation (a negative value) due to the impact of the shot.

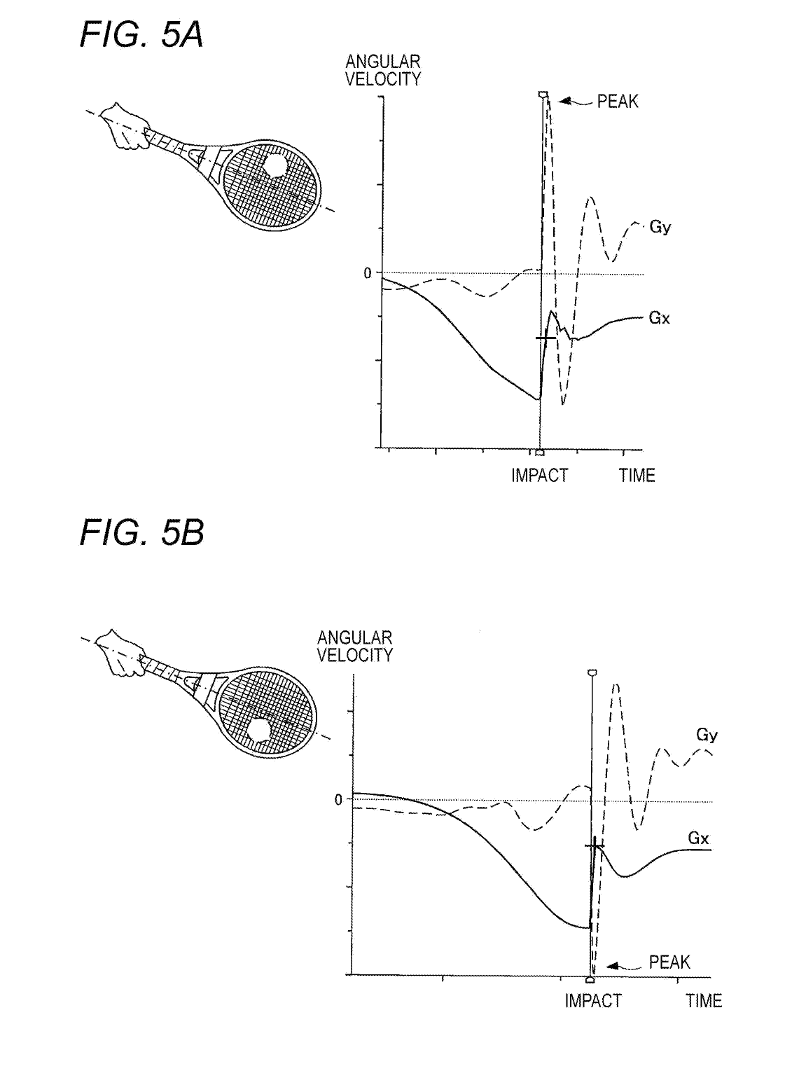

FIGS. 5A and 5B are diagrams illustrating a relationship between the face deflection state at the shot and obtained values (Gx, Gy) by the three-axis angular velocity sensor 16a, FIG. 5A illustrates the state where the tennis ball hits at the upper side of the sweet spot, and FIG. 5B illustrates the state where the tennis ball hits at the lower side of the sweet spot. It is noted that the right graphs in FIG. 5A and FIG. 5B illustrate the temporal changes of the angular velocity Gx and Gy at the shot, in which the solid lines represent Gx and the dashed lines represent Gy.

As illustrated in FIG. 5A, when the tennis ball hits at the upper side of the sweet spot, the angular velocity Gy exhibits a peak in the positive value immediately after the impact. In contrast, as illustrated in FIG. 5B, when the tennis ball hits at the lower side of the sweet spot, the angular velocity Gy exhibits a peak in the negative value immediately after the impact.

As such, based on the sign of the angular velocity Gy immediately after the impact, it can be determined whether the tennis ball hits at the upper side of the sweet spot or at the lower side of the sweet spot of the tennis racket 2.

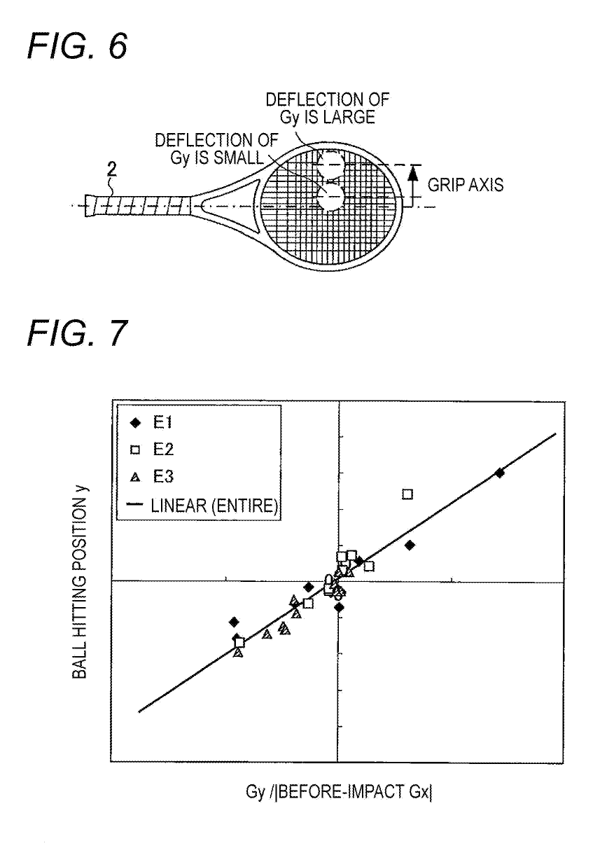

Further, FIG. 6 is a schematic diagram illustrating the magnitude of the deflection of the ball hitting position from the grip axis.

When the strength at which the tennis ball hits at the tennis racket (the strength of the impact) is the same, the larger the deflection of the ball hitting position from the grip axis is, the larger the face deflection amount of the racket (that is, the peak value of the angular velocity Gy immediately after the impact) is, according to the principle of leverage.

In the actual shot, however, the strength of the impact may be different in various ways, and the face deflection amount will be smaller when the swing speed of the tennis racket 2 is slower while the face deflection amount will be larger when the swing speed of the tennis racket 2 is faster.

Thus, the affection on the obtained result of the face deflection amount due to the difference in the swing speed can be suppressed by dividing the angular velocity Gy immediately after the impact by the angular velocity Gx immediately before the impact corresponding to the swing speed of the tennis racket 2 and normalizing it.

That is, the ball hitting position y in the vertical direction (the width direction of the face) at the impact can be estimated by the equation (1).

y=±a×(Gy/Gx)+b (1)

In the equation (1), Gy represents the peak value of the y component of the angular velocity immediately after the impact and Gx represents the value of the x component of the angular velocity immediately before the impact.

It is noted that the values a and b are constant that are determined depending on the attachment state of the three-axis angular velocity sensor 16a and the type of the swing and can be defined based on the statistical data resulted from the actual measurement. For example, the standard value of a may be approximately 2.0 to 3.0 and the standard value of b may be approximately 0 to 2.0. Further, the sign is positive in the case of the forehand stroke while it is negative in the case of the backhand stroke.

FIG. 7 is a schematic diagram illustrating the obtained results of the ball hitting positions y in the forehand strokes.

FIG. 7 illustrates the actual measurements for three subjects (E1 to E3) when a plurality of shot types such as a flat, a spin, and so on of the forehand stroke are made.

As illustrated in FIG. 7, the values of the ball hitting positions y estimated based on the equation (1) have a high correlation with the ball hitting positions measured by the photographing by a high speed camera.

Therefore, the ball hitting position in the vertical direction (the width direction of the face) at the impact can be estimated by calculating the ball hitting position by substituting the values of the angular velocity Gx and Gy obtained at the shot of the tennis ball in the forehand stroke for the equation (1).

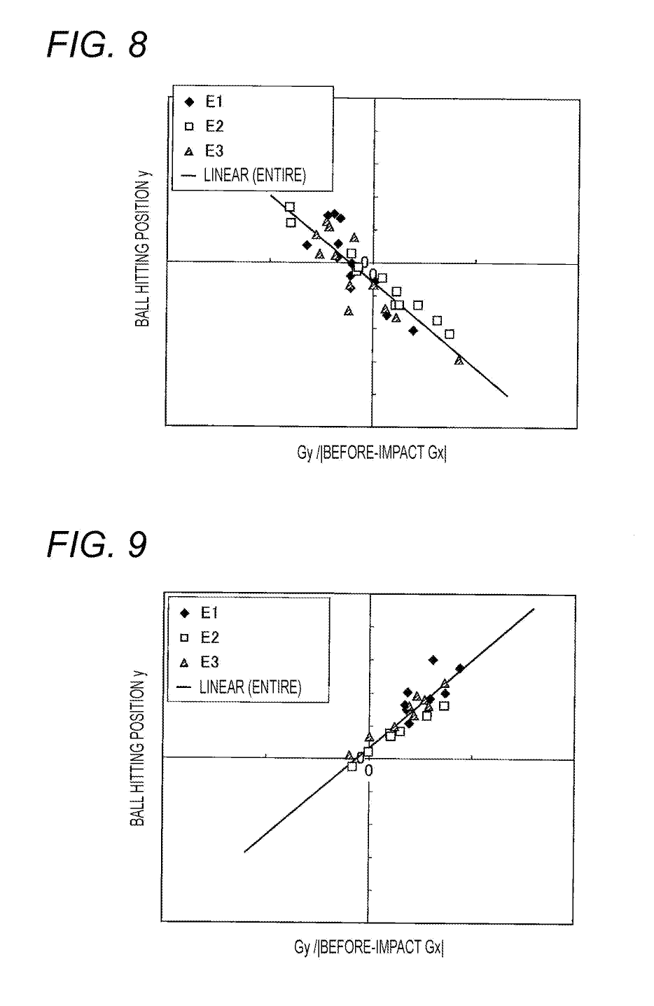

FIG. 8 is a schematic diagram illustrating the obtained results of the ball hitting positions y in the backhand strokes.

Similarly to the case of FIG. 7, FIG. 8 illustrates the actual measurements for the three subjects (E1 to E3) when a plurality of shot types such as a flat, a spin, and the like of the backhand stroke are made.

Further, FIG. 9 is a schematic diagram illustrating the obtained results of the ball hitting positions y in the aces.

Similarly to the cases of FIG. 7 and FIG. 8, FIG. 9 illustrates the actual measurements for the three subjects (E1 to E3) when a plurality of shot types such as a flat, a slice, and the like of the ace are made.

Also in FIG. 8 and FIG. 9, the values of the ball hitting positions y estimated based on the equation (1) have a high correlation with the ball hitting positions measured by the photographing by the high speed camera similarly to FIG. 7.

Therefore, the ball hitting position in the vertical direction (the width direction of the face) at the impact can be estimated by calculating the ball hitting position by substituting the values of the angular velocity Gx and Gy obtained at the shot of the tennis ball in the backhand stroke and the ace for the equation (1). It is noted that the vertical direction of the shot in the forehand stroke approximately corresponds to the lateral direction of the shot in the ace.

Here, the type of the swing such as the forehand stroke, the backhand stroke, the ace, and the like can be determined by deriving the gravity direction from the obtained value of the three-axis acceleration sensor 16b when the tennis racket 2 is held at the ready and further by being based on the waveform of the obtained value of the three-axis angular velocity sensor 16a.

The state estimation unit 51 determines the ball hitting position y estimated based on the equation (1) as the estimation result of the state of the swing and generates the data indicating the estimation result in the preset display form (hereafter, referred to as “result display data”). Further, the state estimation unit 51 causes the storage unit 19 to store the data indicating the calculated ball hitting position y and/or the generated result display data.

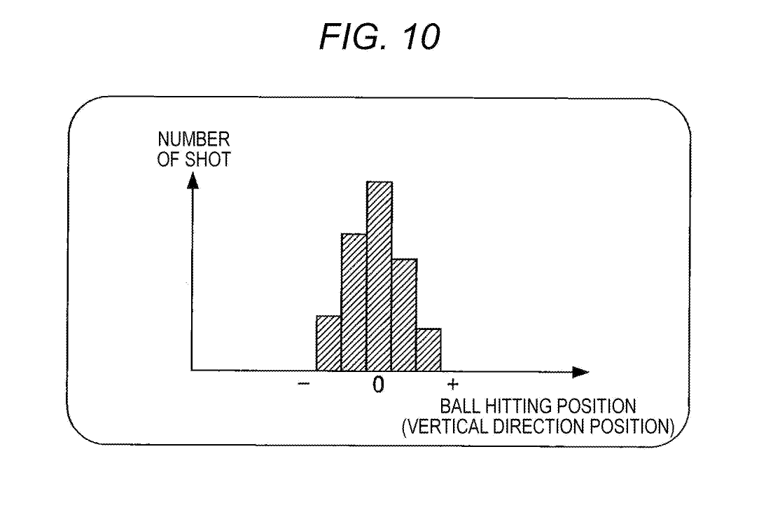

FIG. 10 is a diagram illustrating an example of the display form in which the estimation results of the state of the swings by a histogram.

FIG. 10 illustrates the frequency (the number of shots) for each group divided by the vertical direction of the ball hitting position with respect to the swings made by the player (for example, the swings of the forehand stroke).

When the display form as FIG. 10 is used, the state estimation unit 51 is able to generate the data (the histogram) indicating the deviation of the ball hitting positions for a plurality of swings and present the information indicating the evaluation (the stability of the swing and the like) of the swing made by the player.

It is noted that respective states of the swings may be estimated for the forehand stroke, the backhand stroke, and the ace as the swing made by the player to generate respective histograms illustrated in FIG. 10 for the swings of the forehand stroke, the backhand stroke, and the ace.

Turning back to FIG. 3, the output control unit 52 reads out the result display data generated by the state estimation unit 51 from the storage unit 19 and executes the control for causing the output unit 18 to display the estimation result based on the result display data.

### [Operation]

Next, the operation will be described.

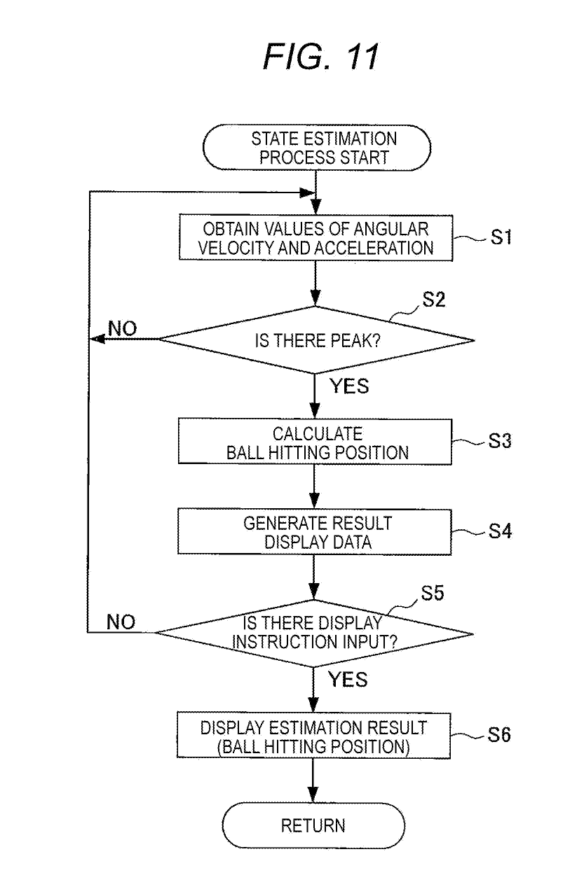

FIG. 11 is a flowchart illustrating an example of a flow of the state estimation process executed by the state estimation apparatus 1 of FIG. 1 having the functional configuration of FIG. 3.

The state estimation process is started in response that the startup of the state estimation process is instructed and inputted via the input unit 17 of the processing unit 1B.

Upon the start of the state estimation process, at step S1, the state estimation unit 51 obtains the obtained result of the values of the angular velocity and the values of the acceleration in the swing of the tennis racket 2 from the three-axis angular velocity sensor 16a and the three-axis acceleration sensor 16b of the sensor unit 1A by communications.

At step S2, the state estimation unit 51 determines whether or not there is a peak in the angular velocity Gy in the swing of the tennis racket 2. Specifically, the state estimation unit 51 makes a determination as to whether or not the angular velocity Gy in the swing of the tennis racket 2 has the peak indicating a larger value than a preset threshold.

If there is no peak in the angular velocity Gy in the swing of the tennis racket 2, it is determined to be NO at step S2 and the process enters step S1.

In contrast, if there is a peak in the angular velocity Gy in the swing of the tennis racket 2, it is determined to be YES at step S2 and the process enters step S3.

At step S3, the state estimation unit 51 calculates the ball hitting position y as the estimation result of the state of the swing according to the equation (1).

At step S4, based on the calculated ball hitting position y, the state estimation unit 51 generates the result display data in the preset display form. It is noted that the data indicating the calculated ball hitting position y and/or the generated result display data are stored in the storage unit 19.

At step S5, the output control unit 52 determines whether or not there is an instruction input for displaying the estimation result of the swing state.

If there is no instruction input for displaying the estimation result of the swing state, it is determined to be NO at step S5 and the state estimation process is repeated.

In contrast, if there is an instruction input for displaying the estimation result of the swing state, it is determined to be YES at step S5 and the process enters step S6.

At step S6, the output control unit 52 causes the output unit 18 to display the ball hitting position y as the estimation result of the state of the swing based on the result display data read out from the storage unit 19.

For example, the output control unit 52 causes the output unit 18 to display the estimation result of the state of the swing by the histogram illustrated in FIG. 10.

After the process of step S6, the state estimation process is repeated.

It is noted that, in the present embodiment, the display of the estimation result of the swing state is executed by the output control unit 52 when the operation of instructing the display is made by the user, as illustrated in step S5. However, the output control unit 52 may display the estimation result of the swing state sequentially for every time when the result display data is generated by the state estimation unit 51.

By the above process, the angular velocity and the acceleration of the tennis racket 2 obtained by the sensor unit 1A are transmitted to the processing unit 1B. Then, based on the received angular velocity and acceleration of the tennis racket 2, the processing unit 1B estimates the ball hitting position at the impact (see FIG. 6) as the state of the swing by the player. The estimated ball hitting position is then notified to the player by displaying the estimation result on the output unit 18 of the processing unit 1B.

Thereby, the state of the swing by the player can be notified to the user.

Therefore, the state of the operation can be properly estimated without depending on the position of the person to be measured.

Further, the ball hitting position in the tennis racket 2 is able to be estimated without photographing the swing made by the player by the high speed camera.

Further, the ball hitting position in the tennis racket 2 is able to be estimated while the same form of the tennis racket as that used in the training and/or the game is maintained.

Moreover, the feedback of the ball hitting position to the player allows for the support of an efficient advancement of the technique of the player.

### Second Embodiment

Next, the second embodiment of the present invention will be described.

In the first embodiment, the sensor unit 1A and the processing unit 1B of the state estimation apparatus 1 are separated and the sensor unit 1A only is mounted to the tennis racket 2.

In contrast, in the state estimation apparatus 1 of the present embodiment, the sensor unit 1A and the processing unit 1B are arranged in an integral manner and the state estimation apparatus 1 including the processing unit 1B is mounted to the tennis racket 2. That is, the state estimation apparatus 1 of the present embodiment is configured as a compact information processing device that is able to be mounted inside the grip and the like of the tennis racket 2.

Therefore, the state estimation apparatus 1 of the present embodiment is configured as an integrated apparatus having the hardware configuration illustrated in FIG. 1 and the functional configuration illustrated in FIG. 3.

It is noted that the output unit 18 in the present embodiment has LEDs (Light Emitting Diode) of red, green, yellow, and so on, and the state of the swing (the ball hitting position) is notified by using these LEDs.

### [Operation]

Next, the operation will be described.

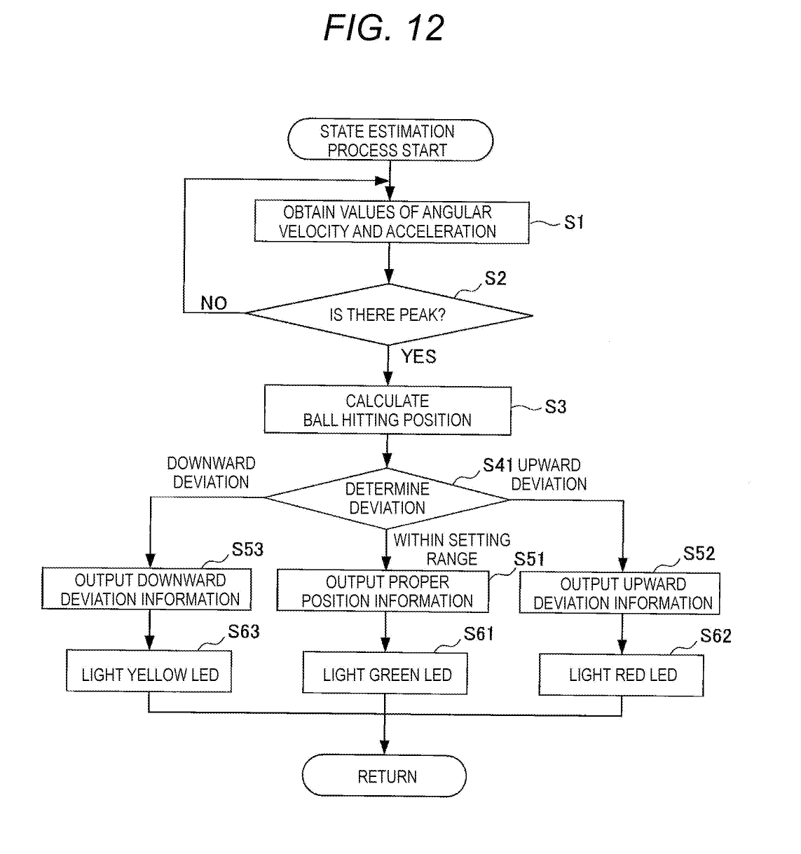

FIG. 12 is a flowchart illustrating an example of a flow of the state estimation process executed by the state estimation apparatus 1 according to the second embodiment.

The state estimation process is started in response that the startup of the state estimation process is instructed and inputted via the input unit 17 of the processing unit 1B.

In the state estimation process illustrated in FIG. 12, the processes of step S1 to step S3 are the same as in the case illustrated in FIG. 11.

At step S41, the state estimation unit 51 determines the magnitude of the deviation of the ball hitting position from the grip axis.

At step S41, if the magnitude of the deviation of the ball hitting position from the grip axis is within a set range (for example, when the ball hits within the range of the sweet spot), the process enters step S51.

Further, at step S41, if the magnitude of the deviation of the ball hitting position from the grip axis is significantly deviated upward from the set range (for example, when the ball hits in the upper side of the sweet spot), the process enters step S52.

Furthermore, at step S41, if the magnitude of the deviation of the ball hitting position from the grip axis is significantly deviated downward from the set range (for example, when the ball hits in the lower side of the sweet spot), the process enters step S53.

At step S51, the state estimation unit 51 outputs, to the output control unit 52, the information indicating that the magnitude of the deviation of the ball hitting position from the grip axis is within the set range (hereafter, referred to as “proper position information”).

At step S52, the state estimation unit 51 outputs, to the output control unit 52, the information indicating that the magnitude of the deviation of the ball hitting position from the grip axis is significantly deviated upward from the set range (hereafter, referred to as “upward deviation information”).

At step S53, the state estimation unit 51 outputs, to the output control unit 52, the information indicating that the magnitude of the deviation of the ball hitting position from the grip axis is significantly deviated downward from the set range (hereafter, referred to as “downward deviation information”).

At step S61, the output control unit 52 lights the green LED of the output unit 18 in response that the proper position information is inputted.

At step S62, the output control unit 52 lights the red LED of the output unit 18 in response that the upward deviation information is inputted.

At step S63, the output control unit 52 lights the yellow LED of the output unit 18 in response that the downward deviation information is inputted.

After the processes of step S61 to step S63, the state estimation process is repeated.

It is noted that, in the present embodiment, the processes of step S51 to S53 are sequentially executed by the state estimation unit 51 after the determination at step S41. However, it may be configured that the determined result at step S41 is stored in the storage unit 19 and the state estimation unit 51 executes the notification of the estimation result of the swing state when the operation of instructing the notification of the estimation result is made by the user.

By the above process, based on the angular velocity and the acceleration of the tennis racket 2 obtained by the sensor unit 1A, the processing unit 1B estimates the ball hitting position at the impact (see FIG. 6) as the state of the swing by the player. The estimated ball hitting position is then notified to the player by lighting the LEDs of the output unit 18 of the processing unit 1B.

Thereby, the state of the swing by the player can be sequentially notified to the user.

Therefore, the state of the operation can be properly estimated without depending on the position of the person to be measured.

### Application Example 1

In the above-described embodiments, it has been described that the estimation result estimated based on the values of the angular velocity and the values of the acceleration obtained by the sensor unit 1A is stored in the storage unit 19.

In contrast, it may be configured that the data of the values of the angular velocity and the values of the acceleration obtained by the sensor unit 1A are stored in advance in the storage unit 19 and, when the notification of the estimation result is instructed, the estimation result of the state of the swing is notified in the instructed notification form (the notification by a predetermined display form, the notification by the LEDs, and the like).

In this case, when the notification of the estimation result is instructed, the state estimation unit 51 reads out the data of the angular velocity and the acceleration from the storage unit 19 and executes the state estimation process and, thereby, generates the data of the estimation result corresponding to the instructed notification form. The output control unit 52 then notifies the estimation result of the state of the swing based on the data of the estimation result generated by the state estimation unit 51.

Thereby, with respect to the swing by the player, the estimation result in the intended notification form can be flexibly presented at any timing.

The state estimation apparatus 1 configured as described above has the three-axis angular velocity sensor 16a and the state estimation unit 51.

The three-axis angular velocity sensor 16a obtains the angular velocity around the rotation axis (the grip axis) of the tennis racket 2 at the time when the tennis ball comes into contact with the tennis racket 2.

The state estimation unit 51 estimates the contact position of the tennis ball on the tennis racket 2 based on the obtained angular velocity.

Thereby, the contact position of the tennis ball on the tennis racket 2 is estimated based on the angular velocity of the tennis racket 2 obtained by the three-axis angular velocity sensor 16a.

Therefore, the state of the operation can be properly estimated without depending on the position of the person to be measured.

Further, based on the orientation of the angular velocity around the rotation axis of the tennis racket 2, the state estimation unit 51 determines which side of the rotation axis the contact position of the tennis ball on the tennis racket 2 is.

This allows the contact position of the tennis ball on the tennis racket 2 to be estimated with higher accuracy.

Further, the state estimation apparatus 1 has the sensor unit 1A and the processing unit 1B.

The sensor unit 1A has the three-axis angular velocity sensor 16a.

The processing unit 1B is configured separately from the sensor unit 1A and has the state estimation unit 51.

Thereby, the members mounted to the tennis racket 2 can be reduced, so that the affection on the swing state due to the installation of the state estimation apparatus 1 can be suppressed.

In addition, the state estimation apparatus 1 further includes the output unit 18.

The output unit 18 outputs the estimation result of the contact position. Further, the output unit 18 outputs the estimation result of the contact position in response to the instruction operation for outputting the estimation result of the contact position.

This allows the estimation result of the contact position to be known at a desired timing.

In addition, the state estimation apparatus 1 further includes the output unit 18.

The output unit 18 sequentially outputs the estimation result of the contact position estimated by the state estimation unit 51.

This allows the estimation results of the contact positions to be known one by one for every time the tennis ball is hit by the tennis racket 2.

In addition, the state estimation apparatus 1 further includes the three-axis acceleration sensor 16b.

The state estimation unit 51 estimates the contact position based on the acceleration of the tennis racket 2 immediately before the contact and the magnitude of the angular velocity around the rotation axis of the tennis racket 2 immediately after the contact between tennis ball and the tennis racket.

This allows for a more accurate estimation of the contact position even when the swing speed is different in various ways.

It is noted that the present invention is not limited to the above-described embodiments and it is intended that modifications, improvements, and the like within the scope where the purpose of the present invention can be achieved are included in the present invention.

Although the estimation result of the state of the swing is outputted by the display of the result display data by the output unit 18 or the LED lighting by the output unit 18 in the above-described embodiments, it is not limited to them. For example, the estimation result of the state of the swing may be outputted by a sound such as voice, an alarm sound, and the like, for example.

Further, although the present invention is applied to the tennis racket in the above-described embodiments, it is not limited to it. For example, the present invention is generally applicable to sporting goods for hitting a moving object, such as a badminton racket, a squash racket, a table-tennis racket, and so on.

Further, although the processing unit 1B of the state estimation apparatus 1 to which the present invention is applied has been described with the example of the PC in the above-described embodiments, it is not limited to it.

For example, the present invention is generally applicable to electronic equipment having an information processing function. Specifically, for example, the present invention is applicable to a notebook personal computer, a printer, a television receiver, a video camera, a mobile navigation device, a smartphone, a mobile phone, a wrist terminal device, a portable game device, and so on.

The series of processes described above can be executed by hardware and can be executed by software.

In other words, the functional configuration of FIG. 3 is a mere example without limitation. That is, as long as the function that is able to execute the series of processes described above as a whole is provided to the state estimation apparatus 1, what function block is used for implementing that function is not limited to the example of FIG. 3 in particular.

Further, one function block may be configured by single hardware, may be configured by single software, or may be configured by the combination thereof.

When the series of processes are executed by the software, the program configuring that software is installed in a computer and the like from a network and/or a recording medium.

The computer may be a computer embedded in dedicated hardware. Further, the computer may be a computer, for example, a general purpose personal computer that is able to execute various functions when various programs are installed.

The recording medium including the above program is not only configured by the removable medium 31 of FIG. 1 that is delivered separately from the apparatus unit in order to provide the program to the user, but also configured by a recording medium and the like that is provided to the user in a manner embedded in the apparatus unit. The removable medium 31 is configured by a magnetic disk (including a floppy disk), an optical disk, a magneto-optical disk, or the like, for example. The optical disk is configured by a CD-ROM (Compact Disk-Read Only Memory), a DVD (Digital Versatile Disk), a Blu-Ray™ Disc, and the like, for example. The magneto-optical disk is configured by an MD (Mini-Disk) and the like. The recording medium provided to the user with embedded in advance in the apparatus unit is configured by the ROM 12 of FIG. 1 in which the program is stored, the hard disk included in the storage unit 19 of FIG. 1, and/or the like, for example.

It is noted that, in the present specification, the steps describing the program stored in the recording medium include not only the processes that are executed sequentially along the described order but also the processes that are executed in parallel or individually without being necessarily executed sequentially.

As set forth, although some embodiments of the present invention have been described, these embodiments are mere examples and not intended to limit the technical scope of the present invention. The present invention can take other various embodiments and, furthermore, various modifications such as omission, replacement, and the like can be made without departing from the spirit of the present invention. These embodiments and their modifications are included in the scope and/or the spirit of the invention described in the present specification and the like and included in the invention recited in the claims and its equivalent.

What is claimed is:

1. An estimation apparatus comprising:
a first obtaining unit configured to obtain a value of an angular velocity around a predetermined rotation axis of a first object, the value of the angular velocity acquired in time when the first object and a second object come into contact with each other; and
an estimation unit configured to estimate a contact position of the second object on the first object based on the value of the angular velocity obtained by the first obtaining unit.

2. The estimation apparatus according to claim 1, wherein the estimation unit determines which side of the predetermined rotation axis the contact position of the second object on the first object is, based on information for an orientation of the angular velocity around the predetermined rotation axis in the first object.

3. The estimation apparatus according to claim 1 further comprising:
a first member including the first obtaining unit; and
a second member arranged separately from the first member and including the state estimation unit.

4. The estimation apparatus according to claim 1 further comprising an output unit to output an estimation result of the contact position,
wherein the output unit outputs the estimation result of the contact position in response to an instruction operation for outputting the estimation result of the contact position.

5. The estimation apparatus according to claim 1 further comprising an output unit for outputting an estimation result of the contact position,
wherein the output unit outputs the estimation result of the contact positions estimated by the state estimation unit.

6. The estimation apparatus according to claim 1 further comprising a second obtaining unit configured to obtain a value of acceleration in the first object,
wherein the state estimation unit estimates the contact position based on a value of acceleration of the first object immediately before a contact of the first object and the second object and a value of magnitude of the angular velocity around the predetermined rotation axis in the first object immediately after the first object and the second object have come into contact with each other.

7. An estimation method using an estimation apparatus, the method including:
obtaining step for obtaining a value of an angular velocity around a predetermined rotation axis of a first object, the value of the angular velocity acquired in time when the first object and a second object come into contact with each other; and
estimating step for estimating a contact position of the second object on the first object based on the obtained value of the angular velocity.

8. A non-volatile computer-readable recording medium storing a program for causing a computer to execute functions as:
obtaining unit configured to obtain a value of an angular velocity around a predetermined rotation axis of a first object, the value of the angular velocity acquired in time when the first object and a second object come into contact with each other; and
estimating unit configured to estimate a contact position of the second object on the first object based on the value of the angular velocity obtained by the obtaining unit.
